(19) United States
(12) Patent Application Publication
(10) Pub. No.: US 2004/0194085 A1
(43) Pub. Date: Sep. 30, 2004

(54) Method and system for providing capability management and prioritization in a computer system

(75) Inventors: Eric Beaubien, Raleigh, NC (US); Kraig Eric Haglund, Raleigh, NC (US); Michael Goldflam, Wake Forest, NC (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ (US)

(21) Appl. No.: 10/063,748

(22) Filed: May 9, 2002

(51) Int. Cl. G06F 9/00; G06F 9/46

(52) U.S. Cl. 718/100

(57) ABSTRACT

There is provided a method and system for facilitating the allocation and management of system resource modules. Applications request services directly from a controlling library rather than directly from the resource. Initially, system service providers register capabilities and relative priorities with the controlling library. Following registration, the controlling library will receive all service requests from applications. In response, the controlling library identifies the available resource having the highest priority and passes the service request to that resource.

### BACKGROUND OF THE INVENTION

The present invention relates generally to the field of computer systems and, more particularly, to systems for managing and allocating system resources to provide optimal performance of the computer system.

The operation of modern computer systems is typically governed by an operating system (OS) software program which essentially acts as an interface between the system resources and hardware and the various applications which make requirements of these resources. Easily recognizable examples of such programs include Microsoft Windows™, UNIX, DOS, VxWorks, and Linux, although numerous additional operating systems have been developed for meeting the specific demands and requirements of various products and devices. In general, operating systems perform the basic tasks which enable software applications to utilize hardware or software resources, such as managing I/O devices, keeping track of files and directories in system memory, and managing the resources which must be shared between the various applications running on the system. Operating systems also generally attempt to ensure that different applications running at the same time do not interfere with each other and that the system is secure from unauthorized use.

Depending upon the requirements of the system in which they are installed, operating systems can take several forms. For example, a multi-user operating system allows two or more users to run programs at the same time. A multiprocessing operating systems supports running a single application across multiple hardware processors (CPUs). A multitasking operating system enables more than one application to run concurrently on the operating system without interference. A multithreading operating system enables different parts of a single application to run concurrently. Real time operating systems (RTOS) execute tasks in a predictable, deterministic period of time. Most modern operating systems attempt to fulfill several of these roles simultaneously, with varying degrees of success.

Of particular interest to the present invention are a class of operating systems commonly referred to as embedded operating systems (EOS), which share many similarities with the general operating systems described above in that they each operate to manage or control the interaction between hardware resources and the applications which require these resources. However, unlike most general operating systems, EOS's tend to be designed to handle specific operations in specific environments and have several general requirements typically including reduced size or footprint, enhanced robustness and autonomy without outside intervention, failsafe measures to ensure reduced downtime, reduced cost, reduced power consumption, etc. EOS's of different sizes and capabilities are used on a wide variety of devices, from traffic lights and mobile phones to complex network elements such as routers and switches. The commonality between this range of devices is that, in each case, their dedicated software applications must run reliably and robustly with reduced requirements in size, cost and power, etc.. Further, in the case of real time embedded operating systems, the resident applications must perform all tasks in a deterministic manner and within predetermined time periods.

Referring specifically to an operating system's ability to manage and allocate system resources, computer systems generally include various resource modules which may co-exist and provide overlapping functionality to the various requesting applications such as I/O devices, memory modules, etc.. Conventionally, a requesting application will make use of these overlapping resource modules through the interaction with a driver API (application programming interface) specific to the resource module being requested (resources may be either hardware or software). The driver API (or API's in general) is essentially a defined set of routines, protocols, and tools for building software applications which can interface with the particular resource. Unfortunately, device driver software is often updated or otherwise modified in response to identified problems, such as porting of the device driver to new hardware, changes or improvements to the driver interface, upgrades to the underlying device, migration to new applications (such as using an existing service in a new manner), etc. However, with each change in the underlying device driver software, requesting applications in conventional systems must be likewise updated to acknowledge such changes. Additionally, by providing application interaction directly with device drivers and, consequently, system resources, conventional systems limit system performance by satisfying application requests with a single resource. Moreover, any system platform changes (for example, changing to a similar device from a different manufacturer) will also require corresponding changes to the application code as well.

Accordingly, there is a need in the art of computer systems for a system and method for managing system resources so as to increase system performance and simultaneously reduce the effects of driver software inconsistencies.

### SUMMARY OF THE INVENTION

The present invention overcomes the problems noted above, and provides additional advantages, by providing an intermediate software or hardware element positioned between a requesting application and the resource provider, the element being utilized during the allocation and management of system resource modules. In one embodiment, applications request services directly from a controlling library rather than directly from the resource provider. Initially, system service providers register capabilities and relative priorities with the controlling library. Following registration, the controlling library will receive all service requests from applications. In response, the controlling library identifies the available resource having the highest priority and passes the service request to that resource. The present invention improves reliability and reuse by effectively shielding the requesting application software from changes to the underlying driver software. Further, the present invention also improves overall system performance by enabling the dynamic division of application requests between several resources as conditions permit.

### BRIEF DESCRIPTION OF THE DRAWINGS

The present invention can be understood more completely by reading the following Detailed Description of the Preferred Embodiments, in conjunction with the accompanying drawings, in which:

FIG. 1 is a generalized block diagram illustrating one embodiment of the computer system of the present invention;

FIG. 2 is an initial, high level flow diagram illustrating one embodiment of a method for managing system resource requests in accordance with the present invention;

FIG. 3 is a flow diagram illustrating one embodiment of a method for registering a service provider with the controlling library in accordance with the present invention; and

FIG. 4 is a flow diagram illustrating one embodiment of a method for handling a service request in accordance with the present invention.

### DETAILED DESCRIPTION OF THE PREFERRED EMBODIMENTS

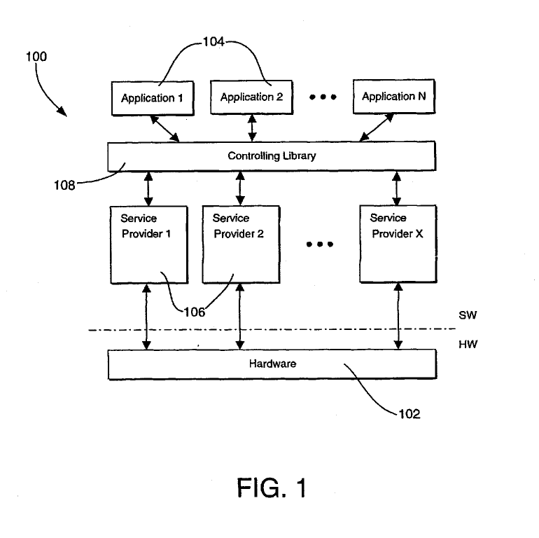

Referring to the Figures and, in particular, to FIG. 1, there is shown a simplified block diagram illustrating one embodiment of an embedded computer system 100 designed in accordance with the present invention. In particular, computer system 100 preferably includes plurality of hardware or software resource modules 102. As is understood in the art, each of these resource modules provide necessary resources to applications which call for those resources. Further, it should be understood that several of the resource modules may provide overlapping or redundant functionality to better serve the needs of the requesting applications and the system in its entirety. System 100 also includes a plurality of calling applications 104 which request access to the services performed by the various resource modules 102.

As briefly discussed above, the applications 104 conventionally interact with the resource modules 102 through a variety of module-specific driver software programs, hereinafter referred to as service providers. These service providers operate to serve up the resources of their associated resource modules for use by the calling application. In the computer system of the present invention, a similar set of service providers 106 is provided for processing all requests for the particular resource module with which it is associated. However, unlike conventional systems, an intermediary element, referred to as a controlling library 108 is also provided for buffering the applications 104 from the inconsistencies of the service providers 106. Further, as will be discussed in additional detail below, by providing the system 100 with the controlling library of the present invention, system performance is substantially improved by enabling the splitting of multiple application requests across several different service providers.

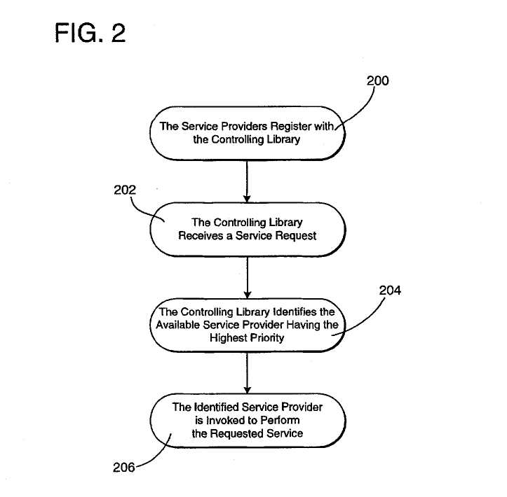

Referring now to FIG. 2, there is shown an initial, high level flow diagram illustrating one embodiment of a method for managing system resource requests in accordance with the present invention. Initially, in step 200, all of the service providers for the available resource modules register with the controlling library. As will be discussed in additional detail below, this registration step educates the controlling library as to the capabilities of the resource modules connected to it. These capabilities may include information such as the type of service being provided and the relative priority of the particular service providers.

Once the service providers have been registered, the controlling library is able to begin handling service requests from applications. Accordingly, in step 202, the controlling library receives a service request from an application. In step 204, the controlling library determines which idle service provider for the requested service has the highest relative priority level. In step 206, the identified service provider is invoked to process the application's request. By providing an intermediary controlling library for interfacing between the calling applications and the service provider software drivers, the system of the present invention substantially improves performance by enabling the efficient routing of service requests based upon assigned service provider priority levels. Also inherently gained is the ability to by-pass inoperable or defective hardware services (devices).

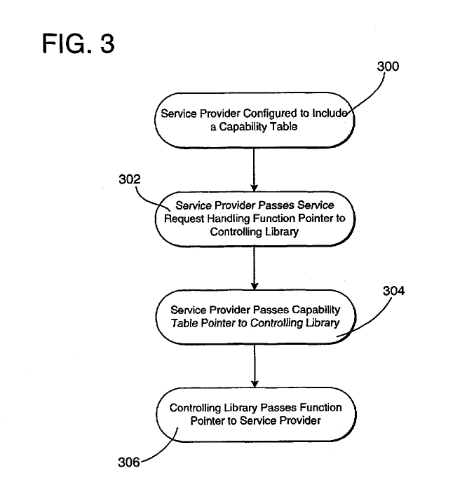

Referring now to FIG. 3, there is shown one embodiment of a method for registering a service provider with the controlling library in accordance with the present invention. As set forth briefly above, in order for the controlling library to efficiently and accurately manage all application service requests, the controlling library must be made aware of the capabilities of each of the service providers and the services provided by the associated resource modules. In addition to providing discrete services, the resource modules may also be further categorized into various modes of services, although it should be understood that mode selection is not required to perform the present invention.

In step 300, the service provider is configured to include a capability table which sets forth the capabilities and relative priority of the service provider in a manner quickly recognizable and usable by the controlling library. In a preferred embodiment, the capability table is configured to include an array of structures, wherein each element of the array corresponds to a specific service or mode of service offered by the service provider. Further, each structure preferably includes several discrete pieces of information. In particular, one such configured array structure may include each of the following: a bit field of arbitrary length denoting a mode or modes supported by the particular service provider being defined; a priority field indicating the relative priority of the given service provider; and a busy field, adaptable by the controlling library to indicate when a particular service provider is busy and thus unavailable to subsequent applications. The following snippet of computer software code represents one possible manner of defining a capability table array structure in accordance with the present invention.

typedef struct
{

U32 modes;
U32 priority;
BOOL busy;

} CNTRL_LIB_CAP;

The above-described structure definition uses 32 bit fields for both the mode and priority designation, however, it should be understood that any number of bits may be used. In this embodiment, each bit within the bit field designating the service mode(s) supported corresponds to a mode of a particular service. If the service provider sets the bit to a 1 the mode is considered supported. Similarly, the priority field indicates the priority level of the service using a pre-defined hierarchy. The busy field provided may simply include a Boolean variable (i.e., TRUE or FALSE) adaptable by the controlling library to indicate whether or not the service provider is busy processing a service request.

According to one embodiment of the registration process of the present invention, all the modes of a particular service are defined in relation to the service. In this manner, one bit field may be utilized to designate both the service and the mode of the service. Accordingly, in this embodiment, services are defined in ascending order starting with 0, and will be used as an index into the capability table. The following snippet of computer software code represents one possible manner of defining the available services in accordance with the present invention.

```
#define NUM_BITS 32
typedef enum
{
    // The first mode for each service is be defined as the service * the number bits
    // used to represent the modes. Only NUM_BITS modes may be defined per service.
    MODE_A1 = SERVICE_A * NUM_BITS,
    MODE_A2,
    MODE_B1 = SERVICE_B * NUM_BITS,
    MODE_B2,
    MODE_B3,
    MODE_C1 = SERVICE_C * NUM_BITS,
} CNTRL_LIB_MODES;
```

Additionally, according to this embodiment of the present invention, mode definition is dependent on the corresponding service and the number of bits used in the mode bit field. Using this methodology, the first mode in each service may be defined as the service number multiplied by the number of bits used in the mode field. Each subsequent mode for that service is then defined in ascending order. The following snippet of computer software code represents one manner of defining a mode definition in accordance with the present invention.

```
#define NUM_BITS 32
typedef enum
{
    // The first mode for each service is be defined as the service * the number bits
    // used to represent the modes. Only NUM_BITS modes may be defined per service.
    MODE_A1 = SERVICE_A * NUM_BITS,
    MODE_A2,
    MODE_B1 = SERVICE_B * NUM_BITS,
    MODE_B2,
    MODE_B3,
    MODE_C1 = SERVICE_C * NUM_BITS,
} CNTRL_LIB_MODES;
```

Once these definitions have been established, the service provider may easily initialize the capability table based on a list of supported modes. The following snippet of computer software code represents one manner for initializing a capability table in accordance with the present invention. In this example, serv_prov_modes defines an array of modes supported by the service provider.

```
void service_provider_init
    // allocate space for capability array
    CNTRL_LIB CAP cap_array[ SERVICE_MAX_VALUE ] ;
    int service_idx;
    int bit_idx, i;
    // initialize the array to zero
    memset ( cap_array, 0, sizeof( CNTRL_LIB_CAP ) * SERVICE_MAX_VALUE ) ;
    // Fill in the modes
    for( i=0; i< sizeof( serv_prov_modes ) ; i++ )
    {
        // Determine which service the mode corresponds to. This also gives
        // the index into the array
        service_idx = serv_prov_modes[i] / NUM_BITS;
        // Determine which mode bit to set by taking the modulus NUM_BITS of the number
        bit_idx = serv_prov_modes[i] % NUM_BITS;
        // Set the bit for this mode
        cap_array[ service_idx ] .modes |= ( 1 << bit_idx ) ;
        // Set the priority for this service. This value is the performance
        // of this service provider relative to others present in the system.
        // The value may be set differently for each service
        cap_array[ service_idx ] .priority = SERV_PROV_PRIORITY;
    }
}
```

Once its capability table has been initialized, the service provider, in step 302, passes a pointer to a service request handling function to the controlling library. This service request handling function is the function in the service provider relating to the requested service. A pointer to the initialized capability table is also passed to the controlling library in step 304, thereby enabling the controlling library to use the information stored within the table to make decisions regarding service requests. In response to each of these pointers, the controlling library passes a function pointer to the service provider in step 306. This function is then called by the service provider upon completion of processing, once again passing control back to the controlling library. In one embodiment, each of these arguments are passed to the controlling library using a registration function. The following snippet of computer software code represents one implementation of a controlling library registration function in accordance with the present invention.

```
// struct used for service provider storage
typedef struct
{
    CNTRL_LIB_CAP sp_cap[ SERVICE_MAX_VALUE ] ;
    int (*pServReq) ( CNTRL_LIB_MODES ) ;
} CNTRL_LIB_SP;
// Global Memory used to reference service provider capabilities
CNTRL_LIB_SP sp_array[ NUM_SERV_PROVIDERS] ;
// Counter of service providers
int cntr1_lib_sp_cnt = 0 ;
// Inputs:  Function pointer, Capability array
// Returns: Function pointer
void * cntrl_lib_register( int(*pReq) (CNTRL_LIB_MODES) , CNTRL_LIB_CAP *pTable )
    // Copy in the passed table
    memcpy( sp_array[ cntr1_lib_sp_cnt ] .sp_cap, pTable,
        (sizeof(CNTRL_LIB_CAP) * SERVICE_MAX_VALUE)) ;
    Set the request function pointer
    sp_array[ cntrl_lib_sp_cnt ] .pServReq = pReq;
    // increment the sp cnt var
    cntrl_lib_sp_cnt++;
    // Return a pointer to the request complete handler
    return cntrl_lib_complete;
```

}

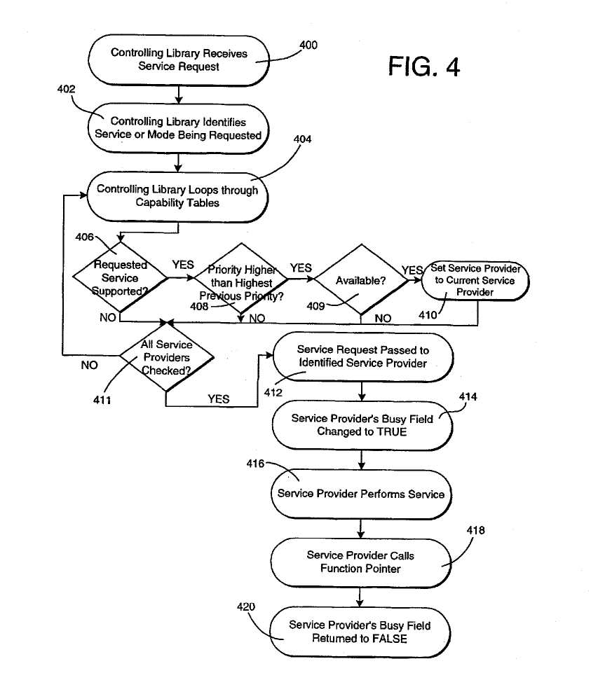

Once each of the service providers has been properly registered with the controlling library, the system is ready to begin handling service requests made by calling applications. Referring now to FIG. 4, there is shown one embodiment of a method for handling a service request in accordance with the present invention. In step 400, the controlling library receives a service (or mode of a service) request from an application. The controlling library is able to utilize the information stored in its capability arrays to optimally select which service provider processes the application's request. In particular, in step 402, the controlling library identifies which service (or mode) is being requested. Next, in step 404, the controlling library loops through the capability tables for each service provider and, in step 406, determines whether each service providers supports the requested service (or mode of service). For each of the service providers identified in step 406, the controlling library determines whether the service provider's priority is higher than the highest priority found thus far in step 408. If so, the controlling library then determines whether that service provider is busy or available in step 409. If so, the current service provider is set as the service provider to receive the service request and the controlling library continues to the next service provider. In step 411, it is determined whether all registered service providers have been checked. If not, the controlling library returns to step 404 and proceeds to the next provider.

However, once the available service provider supporting the request service and having the highest priority is identified, the service request is passed to the service provider in step 412 using the service request handling function pointer passed during the registration process. In order to avoid passing a second request to the same service provider, the busy field value in the capability table entry for the service provider is changed to TRUE in step 414. Next, in step 416, the service provider performs the requested service. In step 418, following completion of the service, the service provider calls the function pointer passed during registration thereby returning control to the controlling library. In step 420, the controlling library returns the busy field value in the service provider's capability table entry to FALSE, thereby rendering the service provider capable of receiving new service requests. The following snippet of computer software code represents one manner of a processing service requests in accordance with the present invention.

#define NO_SP Oxffffffff
// Inputs: Mode
// Returns: Nothing
void cntrl_lib_handle_request( CNTRL_LIB_MODES mode )
{

int i;
int service_idx;
int bit_idx;
U32 high_priority =0;
U32 found_idx = NO_SP;
// Determine which service the mode corresponds to. This also gives
// the index into the controlling library capability tables
service_idx = serv_prov_modes[i] / NUM_BITS;
// Determine which mode bit to check by taking the modulus NUM_BITS of the number
bit_idx = serv_prov_modes[i] % NUM_BITS;
// Loop through the registered service providers
for ( i=0; i< NUM_SERV_PROVIDERS; i++ )
{

// Check to see if this service provider supports the passed mode
if( sp_array[i] .sp_cap[service_idx] .modes & (1<<bit_idx) )
{

// check to see if this is the highest priority found thus far
if ( sp_array[i] .sp_cap[service_idx] .priority > high_priority )
{

// check to see if this service provider is busy
if( sp_array[i] .sp_cap[service_idx] .busy == FALSE )
{

found_idx = i;
high_priority = sp_array[i] .sp_cap[service_idx] .priority;

}

}

}

}
// pass the request to the service provider if found and set its busy status
if( found_idx != NO_SP }
{

sp_array[found_idx] .sp_cap[service_idx] .busy = TRUE;
(sp_array[found_idx] .pServReq) ( mode ) ;

}

}

By providing an intermediary controlling library for interfacing between the requesting applications and the service provider software drivers, the system of the present invention substantially improves performance by enabling the efficient routing of service requests based upon assigned service provider priority levels. This leaves application software unaffected by removals, additions, or modifications to the service providers. Further, the presence of the controlling library also allows efficient management of the application service requests.

While the foregoing description includes many details and specificities, it is to be understood that these have been included for purposes of explanation only, and are not to be interpreted as limitations of the present invention. Many modifications to the embodiments described above can be made without departing from the spirit and scope of the-invention, as is intended to be encompassed by the following claims and their legal equivalents.

What is claimed is:

1. A system for enabling resource request management, comprising:
a plurality of resource modules for performing various services requested by a plurality of calling applications;
a plurality of service providers associated with the plurality of resource modules for processing requests for resource modules from the plurality of calling applications; and
a controlling library operatively connected to the plurality of service providers and the plurality of calling applications,
wherein the controlling library operates to receive service requests from the plurality of calling applications, determine appropriate service providers to receive the requests, and pass the requests to the appropriate service providers for subsequent fulfillment of the service requests.

2. The system of claim 1, wherein the controlling library further comprises:
means for receiving a service request from one of the plurality of calling applications;
means for identifying a highest priority available service provider from the plurality of service providers in response to the received service request; and
means for invoking the identified service provider having the highest priority available to perform the requested service.

3. The system of claim 1, wherein each of the plurality of service providers further comprises:
a capability table for including information regarding at least priority and capability information;
means for passing a service request handling function pointer to the controlling library for enabling the controlling library to properly invoke the service provider;
means for passing a capability table pointer to the controlling library for enabling the controlling library to properly determine the priority and capabilities of the service provider; and
means for receiving a controlling library function pointer from the controlling library for enabling the passing of control back to the controlling library upon completion of a requested service.

4. The system of claim 3, wherein the capability table is configured to include the following:
a bit field for containing information representative of at least one service supported by the service provider;
a priority field for containing information representative of a relative priority of the service provider; and
a busy field for containing information indicating whether the service provider is available to respond to service requests.

5. The system of claim 3, wherein the capability table is configured as an array of structures, wherein each element in the array corresponds to a specific service supported by the service provider and each structure includes capability and priority information for a particular service.

6. The system of claim 3, wherein the controlling library further comprises:
means for receiving a service request from one of the plurality of calling applications;
means for identifying the received service request;
means for looping through the capability tables for each of the plurality of service providers to identify the service provider which supports the received service request, has a highest priority and is available; and
means for passing the received service request to the identified service provider.

7. The system of claim 4, wherein the means for looping through the capability tables further comprises:
means for examining the capability table of each of the plurality of service providers to determine whether the received service request is supported by the service provider;
means for determining whether a currently examined service provider has a priority higher than any previously examined available service provider if it is determined that the received service request is supported by the currently examined service provider;
means for determining whether the currently examined service provider is available to respond to the received service request if it is determined that the currently examined service provider has a priority higher than any previously examined available service provider;
means for setting the currently examined service provider to be the identified service provider if it is determined that the currently examined service provider is available to respond to the received service request;
means for determining whether all service providers have been checked; and
means for proceeding to a next service provider if it is determined that all service providers have not been checked.

8. The system of claim 6, further comprising:
means for changing the identified service provider's capability table to indicate that the identified service provider is busy and unavailable for performance of additional service requests.

9. A method for enabling resource request management, comprising the steps of:
receiving a service request from one of the plurality of a calling applications into a controlling library operatively connected to the plurality of calling applications and a plurality of service providers;
identifying a highest priority available service provider from the plurality of service providers in response to the received service request; and
invoking the identified service provider having the highest priority available to perform the requested service.

10. The method of claim 9, further comprising the step of configuring each of the plurality of service providers to include a capability table for including information regarding at least priority and capability information.

11. The method of claim 10, further comprising the steps of:
receiving, into the controlling library, a service request handling function pointer from each of the plurality of service providers for enabling the controlling library to properly invoke the service provider;
receiving, into the controlling library, a capability table pointer from each of the plurality of service providers for enabling the controlling library to properly determine the priority and capabilities of the service provider; and
passing, to each of the plurality of service providers, a controlling library function pointer from the controlling library for enabling the passing of control back to the controlling library upon completion of a requested service.

12. The method of claim 10, further comprising the steps of:
configuring the capability table for each of the plurality of service providers to include a bit field for containing information representative of at least one service supported by the service provider;
configuring the capability table for each of the plurality of service providers to include a priority field for containing information representative of a relative priority of the service provider; and
configuring the capability table for each of the plurality of service providers to include a busy field for containing information indicating whether the service provider is available to respond to service requests.

13. The method of claim 10, further comprising the step of configuring the capability table for each of the plurality of service providers to include an array of structures, wherein each element in the array corresponds to a specific service supported by the service provider and each structure includes capability and priority information for a particular service.

14. The method of claim 11, further comprising the steps of:
looping through the capability tables for each of the plurality of service providers to identify the service provider which supports the received service request, has a highest priority and is available; and
passing the received service request from the controlling library to the identified service provider for performance of the requested service.

15. The method of claim 14, wherein the step of looping through the capability tables further comprises the steps of:
examining the capability table of each of the plurality of service providers to determine whether the received service request is supported by the service provider;
determining whether a currently examined service provider has a priority higher than any previously examined available service provider if it is determined that the received service request is supported by the currently examined service provider;
determining whether the currently examined service provider is available to respond to the received service request if it is determined that the currently examined service provider has a priority higher than any previously examined available service provider;
setting the currently examined service provider to be the identified service provider if it is determined that the currently examined service provider is available to respond to the received service request;
determining whether all service providers have been checked; and
proceeding to a next service provider if it is determined that all service providers have not been checked.

16. The method of claim 14, further comprising the steps of:
changing the identified service provider's capability table to indicate that the identified service provider is busy and unavailable for performance of additional service requests;
performing the requested service by the identified service provider;
returning control to the controlling library; and
changing the identified service provider's capability table to indicate that the identified service provider is available for performance of additional service requests.

17. The method of claim 16, wherein the step of returning control to the controlling library further comprises the step of calling the controlling library function pointer.

18. A computer readable medium incorporating instructions for enabling resource request management, the instructions comprising:
one or more instructions for receiving a service request from one of the plurality of a calling applications into a controlling library operatively connected to the plurality of calling applications and a plurality of service providers;
one or more instructions for identifying a highest priority available service provider from the plurality of service providers in response to the received service request; and
one or more instructions for invoking the identified service provider having the highest priority available to perform the requested service.

19. The computer readable medium of claim 18, further comprising one or more instructions for configuring each of the plurality of service providers to include a capability table for including information regarding at least priority and capability information.

20. The computer readable medium of claim 19, further comprising:
one or more instructions for receiving, into the controlling library, a service request handling function pointer from each of the plurality of service providers for enabling the controlling library to properly invoke the service provider;
one or more instructions for receiving, into the controlling library, a capability table pointer from each of the plurality of service providers for enabling the controlling library to properly determine the priority and capabilities of the service provider; and
one or more instructions for passing, to each of the plurality of service providers, a controlling library function pointer from the controlling library for enabling the passing of control back to the controlling library upon completion of a requested service.

21. The computer readable medium of claim 19, further comprising:
one or more instructions for configuring the capability table for each of the plurality of service providers to include a bit field for containing information representative of at least one service supported by the service provider;
one or more instructions for configuring the capability table for each of the plurality of service providers to include a priority field for containing information representative of a relative priority of the service provider; and
one or more instructions for configuring the capability table for each of the plurality of service providers to include a busy field for containing information indicating whether the service provider is available to respond to service requests.

22. The computer readable medium of claim 19, further comprising one or more instructions for configuring the capability table for each of the plurality of service providers to include an array of structures, wherein each element in the array corresponds to a specific service supported by the service provider and each structure includes capability and priority information for a particular service.

23. The computer readable medium of claim 20, further comprising:
one or more instructions for looping through the capability tables for each of the plurality of service providers to identify the service provider which supports the received service request, has a highest priority and is available; and
one or more instructions for passing the received service request from the controlling library to the identified service provider for performance of the requested service.

24. The computer readable medium of claim 23, wherein the one or more instructions for looping through the capability tables further comprise:
one or more instructions for examining the capability table of each of the plurality of service providers to determine whether the received service request is supported by the service provider;
one or more instructions for determining whether a currently examined service provider has a priority higher than any previously examined available service provider if it is determined that the received service request is supported by the currently examined service provider;
one or more instructions for determining whether the currently examined service provider is available to respond to the received service request if it is determined that the currently examined service provider has a priority higher than any previously examined available service provider;
one or more instructions for setting the currently examined service provider to be the identified service provider if it is determined that the currently examined service provider is available to respond to the received service request;
one or more instructions for determining whether all service providers have been checked; and
one or more instructions for proceeding to a next service provider if it is determined that all service providers have not been checked.

25. The computer readable medium of claim 23, further comprising:
one or more instructions for changing the identified service provider's capability table to indicate that the identified service provider is busy and unavailable for performance of additional service requests;
one or more instructions for performing the requested service by the identified service provider;
one or more instructions for returning control to the controlling library; and
one or more instructions for changing the identified service provider's capability table to indicate that the identified service provider is available for performance of additional service requests.

26. The computer readable medium of claim 25, wherein the one or more instructions for returning control to the controlling library further comprise one or more instructions for calling the controlling library function pointer.
